(19) United States
(12) Patent Application Publication
(10) Pub. No.: US 2014/0359381 A1
(43) Pub. Date: Dec. 4, 2014

(54) MEMORY CONTROLLER AND DATA STORAGE DEVICE

(71) Applicants: Ken Takeuchi, Bunkyo-ku (JP); Shuhei Tanakamaru, Bunkyo-ku (JP)

(72) Inventors: Ken Takeuchi, Bunkyo-ku (JP); Shuhei Tanakamaru, Bunkyo-ku (JP)

(73) Assignee: THE UNIVERSITY OF TOKYO, Tokyo (JP)

(21) Appl. No.: 14/355,033

(22) PCT Filed: Mar. 30, 2012
(86) PCT No.: PCT/JP2012/058581

§ 371 Date: Jul. 8, 2014

(30) Foreign Application Priority Data
Nov. 2, 2011 (JP) 2011-241422

(51) Int. Cl. G06F 11/07

(52) U.S. Cl. CPC G06F 11/076
USPC 714/704

(57) ABSTRACT

A memory controller sets an estimated cell error ratio CERest based on an estimated retention time Tret obtained from a calculated bit error ratio BER, a number of rewrite times NW/E, data Datatag of a target cell and data Dataadj of memory cells surrounding the target cell, sets an upper-level page LLRu and a lower-level page LLRl with regard to all bits of read-out one-page data using the set estimated cell error ratio CERest and performs error correction and decoding of data read out from a flash memory using the settings of the upper-level page LLRu and the lower-level page LLRl. This improves the error correction capability, while suppressing an increase in processing time.

### TECHNICAL FIELD

The present invention relates to a memory controller and a data storage device. More specifically, the invention relates to a memory controller and a data storage device including the memory controller configured such as to, in the case of writing data into a non-volatile memory having a plurality of non-volatile memory cells, encode the data to be written into a specified code which is decodable by an operation using a log-likelihood ratio and control the non-volatile memory to store the encoded code data into the non-volatile memory, and in the case of reading data from the non-volatile memory, control the non-volatile memory to read out code data of a predefined size from the non-volatile memory and decode the code data by iterative processing based on the probability using the log-likelihood ratio.

### BACKGROUND ART

A technique of performing error correction for data output from a flash memory and outputting the error-corrected data to a host device has been proposed with regard to this type of memory controller (for example, Non-Patent Literature 1). This controller performs error correction of data and is thereby enabled to output data of the higher reliability. An LDPC (low-density parity-check) code has been proposed as the error correcting code (ECC) used for such error correction (for example, Non-Patent Literature 2).

### CITATION LIST

### Non-Patent Literature

[NPL 1] “Koredakeha shitte okitai NAND flash memory no kilo (Fundamental Knowledge of NAND Flash Memory)”, Semiconductor Storage 2012, Nikkei Business Publications, Inc., Jul. 29, 2011, p 68-p 79
[NPL 2] “Shingo shori gijutsuniyori SSD no shinraiseiwo oohabani koujou (Signal processing technology significantly improves the reliability of SSD”, Semiconductor Storage 2012, Nikkei Business Publications, Inc., Jul. 29, 2011, p 58-p 67

### SUMMARY OF INVENTION

In the case of using the LDPC code for ECC in the above memory controller, the technique of performing recursive repeat operation using the log-likelihood ratio (LLR) indicating the probability of soft value data, for example, the sum-product algorithm, is generally used as the decoding method of the encoded code data, in order to enhance the correction capability. This technique pre-assumes a distribution of threshold voltage in a graph with the number of flash memory cells as ordinate and the threshold voltage as abscissa and sets an initial value of LLR using the pre-assumed distribution of threshold voltage and a reference voltage which is a voltage to be applied to the word line in the process of reading out data from the flash memory. The pre-assumed distribution of threshold voltage may, however, be significantly different from the actual distribution of threshold voltage. This may cause problems like the increase number of repetitions of the repeat operation and wrong correction. An available technique that minimizes the possibility of such problems increases the number of reference voltages and uses data read out from the flash memory with respect to each reference voltage. This technique may, however, increase the number of data read-out times from the flash memory and increase the time spent on arithmetic processing. Especially a multi-bit cell, in which data of 2 or more bits is stored in each flash memory cell, has a significant increase in number of reference voltages and thereby increases the processing time. There is accordingly a need to provide a method that reduces wrong correction and improves the error correction capability, while suppressing an increase in processing time.

An object of the invention is to improve the error correction capability, while suppressing an increase in processing time with regard to the memory controller and the data storage device.

The memory controller and the data storage device of the invention employ the following aspects and embodiments, in order to achieve the above object.

A memory controller according to the present invention is a memory controller configured such as to, in the case of writing data into a non-volatile memory having a plurality of non-volatile memory cells, encode the data to be written into a specified code which is decodable by an operation using a log-likelihood ratio and control the non-volatile memory to store the encoded code data into the non-volatile memory, and in the case of reading out data from the non-volatile memory, control the non-volatile memory to read out code data of a predefined size from the non-volatile memory and decode the code data by the operation using the log-likelihood ratio, the memory controller including: a bit error ratio calculator that, when code data of a predefined size is read out from the non-volatile memory, calculates a bit error ratio which is a ratio of a number of bits where a bit inversion error occurs in the read-out data of the predefined size to a total number of bits in the read-out data of the predefined size; an estimated cell error probability setter that performs an estimated cell error probability setting process with regard to all bits of the read-out data of the predefined size, wherein the estimated cell error probability setting process sets an estimated cell error probability, which is an estimated value of probability of occurrence of a bit error in a target cell that is a non-volatile memory cell storing 1 bit of the read-out data of the predefined size, based on the calculated bit error ratio, data of the target cell and data of a non-volatile memory cell in a specified range from the target cell; and a log-likelihood ratio setter that sets the log-likelihood ratio with regard to all the bits of the read-out data of the predefined size using the set estimated cell error probability.

In the case of reading out from the non-volatile memory, the memory controller of the invention controls the non-volatile memory to read out the code data of the predefined size from the non-volatile memory. When the code data of the predefined size is read out from the non-volatile memory, the memory controller calculates the bit error ratio which is the ratio of the number of bits where a bit inversion error occurs in the read-out data of the predefined size to the total number of bits in the read-out data of the predefined size. The memory controller sets the estimated cell error probability, which is the estimated value of probability of the occurrence of a bit error in the target cell that is the non-volatile memory cell storing 1 bit of the read-out data of the predefined size, based on the calculated bit error ratio, the data of the target cell and the data of the non-volatile memory cell in the specified range from the target cell. The estimated cell error probability is set with regard to all the bits of the read-out data of the predefined size. The memory controller sets the log-likelihood ratio with regard to all the bits of the read-out data of the predefined size using the set estimated cell error probability, and decodes the code data by iterative processing based on the probability using the set log-likelihood ratio. Data of a certain non-volatile memory cell is affected by what data are stored in other memory cells surrounding the certain memory cell. It is accordingly expected that the cell error probability which is the probability of the occurrence of a bit error in the data of the certain memory cell of interest is changed by the data of the surrounding memory cells. The memory controller of this aspect sets the estimated cell error probability based on the calculated bit error ratio, the data of the target cell and the data of the non-volatile memory cell in the specified range from the target cell and sets the log-likelihood ratio with regard to all the bits of the read-out data of the predefined size using the set estimated cell error probability. This allows for setting the log-likelihood ratio further reflecting the actual state of the non-volatile memory cell and thereby enhances the correction capability, compared with the configuration of setting the log-likelihood ratio using a pre-assumed distribution of threshold voltage. This also suppresses an increase in number of data read-out times, compared with the configuration of increasing the number of reference voltages and reading out data from a flash memory with respect to each of the reference voltages. As a result, this improves the error correction capability, while suppressing an increase in processing time.

In the memory controller of the present invention, the estimated cell error probability setting process may set an estimated retention time, which is an estimated value of retention time without data reading and writing from and to the non-volatile memory, using the calculated bit error ratio, and sets the estimated cell error probability using the set estimated retention time, the data of the target cell and the data of the non-volatile memory cell in the specified range from the target cell. In the non-volatile memory, the longer retention time without data reading and writing is likely to increase the bit error ratio. The memory controller of this aspect sets the estimated retention time which is the estimated value of retention time without data reading and writing from and to the non-volatile memory and sets the estimated cell error probability using the set estimated retention time, the data of the target cell and the data of the non-volatile memory cell in the specified range from the target cell. This allows for setting the estimated cell error probability with the higher accuracy. As a result, this causes the log-likelihood ratio to be set with the higher accuracy and further improves the error correction capability. According to one embodiment of this aspect, the memory controller further including: a first table storage unit that stores a first table predefined as a relationship between the bit error ratio and the estimated retention time; and a second table storage unit that stores a second table predefined as a relationship between the estimated retention time, the data of the target cell and the data of the non-volatile memory cell in the specified range from the target cell. The estimated cell error probability setting process sets the estimated retention time using the calculated bit error ratio and the first table, and sets the estimated cell error probability using the set estimated retention time, the data of the target cell, the data of the non-volatile memory cell in the specified range from the target cell and the second table.

The memory controller according to the above aspect of the invention setting the estimated cell error probability using the set estimated retention time, the data of the target cell and the data of the non-volatile memory cell in the specified range from the target cell may further include a rewrite time counter that counts a number of rewrite times which is a number of erase times of data stored in the non-volatile memory, and the estimated cell error probability setting process may set the estimated cell error probability using the counted number of rewrite times, the set estimated retention time, the data of the target cell and the data of the non-volatile memory cell in the specified range from the target cell. In the non-volatile memory, the greater number of rewrite times is likely to increase the probability of the occurrence of a bit error in a certain memory cell. The memory controller of this aspect counts the number of rewrite times and sets the estimated cell error probability using the counted number of rewrite times, the set estimated retention time, the data of the target cell and the data of the non-volatile memory cell in the specified range from the target cell. This allows for setting the estimated cell error probability with the higher accuracy. As a result, this causes the log-likelihood ratio to be set with the higher accuracy and further improves the error correction capability. According to one embodiment of this aspect of the memory controller, the second table may be predefined as a relationship between the number of rewrite times, the estimated retention time, the data of the target cell, the data of the non-volatile memory cell in the specified range from the target cell and the estimated cell error probability, and the estimated cell error probability setting process may set the estimated cell error probability using the counted number of rewrite times, the set estimated retention time, the data of the target cell, the data of the non-volatile memory cell in the specified range from the target cell and the second table. The first table may be predefined as a relationship between the bit error ratio, the estimated retention time and the number of rewrite times, and the estimated cell error probability setting process may set the estimated retention time using the calculated bit error ratio, the number of rewrite times and the first table. Further the memory controller of the present invention wherein when data is written into the non-volatile memory, the bit error ratio calculator stores a bit number of “1”s or “0”s included in data of the predefined size stored in the non-volatile memory out of the data to be written, prior to encoding the data to be written into the specified code, as a pre-coding bit number, and when data of the predefined size is read out from the non-volatile memory, the bit error ratio calculator calculates the bit error ratio using a bit number of “1”s or “0”s of the read-out data and the pre-coding bit number.

In this memory controller of the invention, the non-volatile memory may be a flash memory, and the data of the predefined size may be one-page data of the flash memory. According to one embodiment of this aspect, the non-volatile memory may be a NAND-time flash memory including the non-volatile memory cells, each being capable of storing 2-bit data, and when an upper-level page is defined as 1001 in an ascending order of a threshold voltage in the data stored in the non-volatile memory cell and a lower-level page is defined as 1100 in the ascending order of the threshold voltage, the bit error ratio calculator may calculate an error that changes “1” to “0” in the lower-level page, as the bit error ratio. The non-volatile memory may be a NAND-time flash memory including the non-volatile memory cells, each being capable of storing 2-bit data, wherein

when an upper-level page is defined as 1001 in an ascending order of a threshold voltage in the data stored in the non-volatile memory cell and a lower-level page is defined as 1100 in the ascending order of the threshold voltage, the bit error ratio calculator may calculate an error that changes “0” to “1” in the lower-level page, as the bit error ratio.

In the memory controller of the invention, the specified code may be a low-density parity-check code.

A data storage device according to the present invention is a data storage device capable of storing data, including: the memory controller according to any one of the above aspects and embodiments of the invention; and the non-volatile memory. This memory controller is basically configured such as to, in the case of writing data into a non-volatile memory having a plurality of non-volatile memory cells, encode the data to be written into a specified code which is decodable by an operation using a log-likelihood ratio and control the non-volatile memory to store the encoded code data into the non-volatile memory, and in the case of reading out data from the non-volatile memory, control the non-volatile memory to read out code data of a predefined size from the non-volatile memory and decode the code data by the operation using the log-likelihood ratio. The memory controller includes: a bit error ratio calculator that, when code data of a predefined size is read out from the non-volatile memory, calculates a bit error ratio which is a ratio of a number of bits where a bit inversion error occurs in the read-out data of the predefined size to a total number of bits in the read-out data of the predefined size; an estimated cell error probability setter that performs an estimated cell error probability setting process with regard to all bits of the read-out data of the predefined size, wherein the estimated cell error probability setting process sets an estimated cell error probability, which is an estimated value of probability of occurrence of a bit error in a target cell that is a non-volatile memory cell storing 1 bit of the read-out data of the predefined size, based on the calculated bit error ratio, data of the target cell and data of a non-volatile memory cell in a specified range from the target cell; and a log-likelihood ratio setter that sets the log-likelihood ratio with regard to all the bits of the read-out data of the predefined size using the set estimated cell error probability.

The data storage device of the invention includes the memory controller according to any one of the above aspects and embodiments of the invention and accordingly has the similar advantageous effects to those of the memory controller of the invention, for example, the advantageous effects of improving the error correction capability while suppressing an increase in processing time.

### BRIEF DESCRIPTION OF DRAWINGS

FIG. 1 is an explanatory diagram illustrating the general configuration of an SSD (Solid State Driver) 20, on which a memory controller 30 according to an embodiment of the invention is mounted to store data from a host device 10 such as a personal computer;

FIG. 2 is an explanatory diagram illustrating the general structure of a flash memory cell array 24;

FIG. 3 is an explanatory diagram illustrating data to be stored in a flash memory cell 24a;

FIG. 4 is a flowchart showing an exemplary writing process performed by the memory controller 30 to write data from the host device 10 into a flash memory 22;

FIG. 5 is a flowchart showing an exemplary LLR setting process to set an upper-level page LLRu and a lower-level page LLRl performed by an LLR setting unit 34;

FIG. 6 is an explanatory diagram illustrating one example of an estimated retention time setting table 40a;

FIG. 7 is an explanatory diagram illustrating one example of an EP table 40c;

FIG. 8 is an explanatory diagram illustrating a process of setting cell error ratios CERl and CERu; and

FIG. 9 is an explanatory diagram illustrating one example of the EP table 40c shown in FIG. 7, where b1 to b16 denote cell error ratios CER when the data of a left cell are “11”, “01”, “00” and “10”, cell error ratios CER when the data of a right cell are “11”, “01”, “00” and “10” and cell error ratios CER when the data of an upper cell are “11”, “01”, “00” and “10”.

### DESCRIPTION OF EMBODIMENTS

Some aspects of the invention are described below with reference to an embodiment.

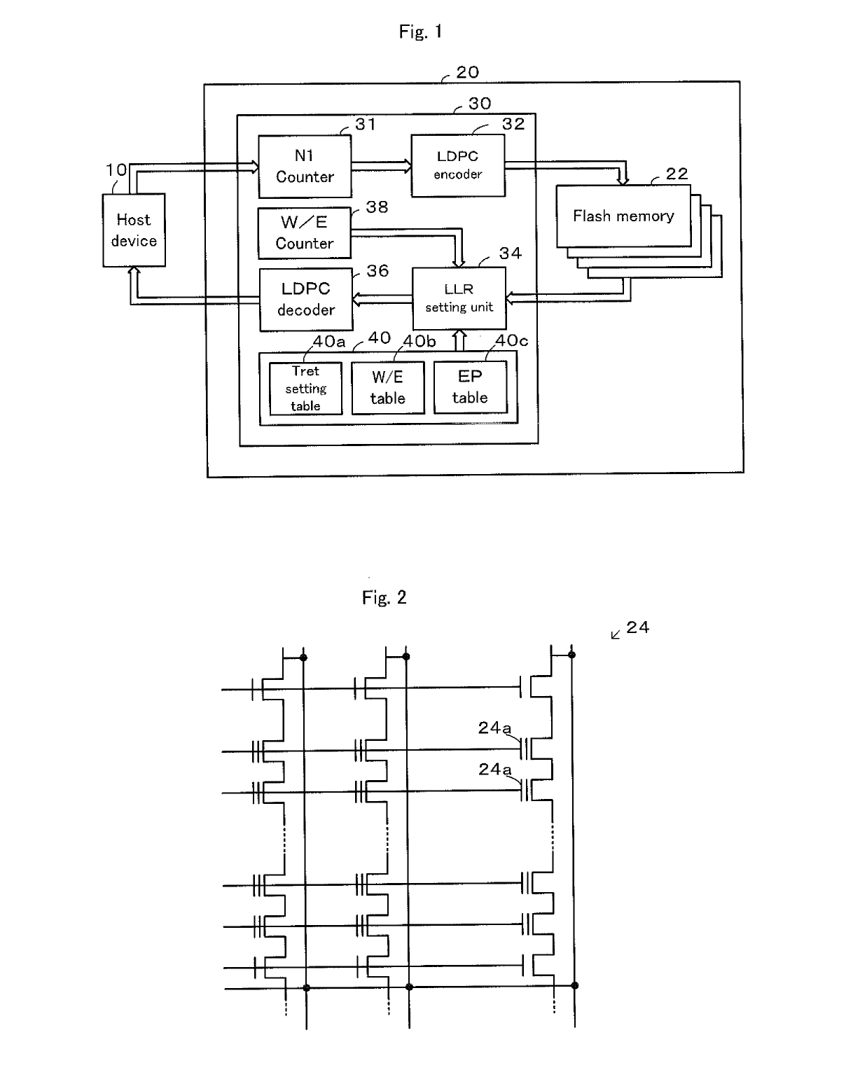

FIG. 1 is an explanatory diagram illustrating the general configuration of an SSD (Solid State Driver) 20, on which a memory controller 30 according to an embodiment of the invention is mounted to store data from a host device 10 such as a personal computer. The SSD 20 is configured as a high-capacity data storage device to store various application programs and various data, and includes flash memories 22, each configured by a NAND-type flash memory, and the memory controller 30 to control the flash memories 22.

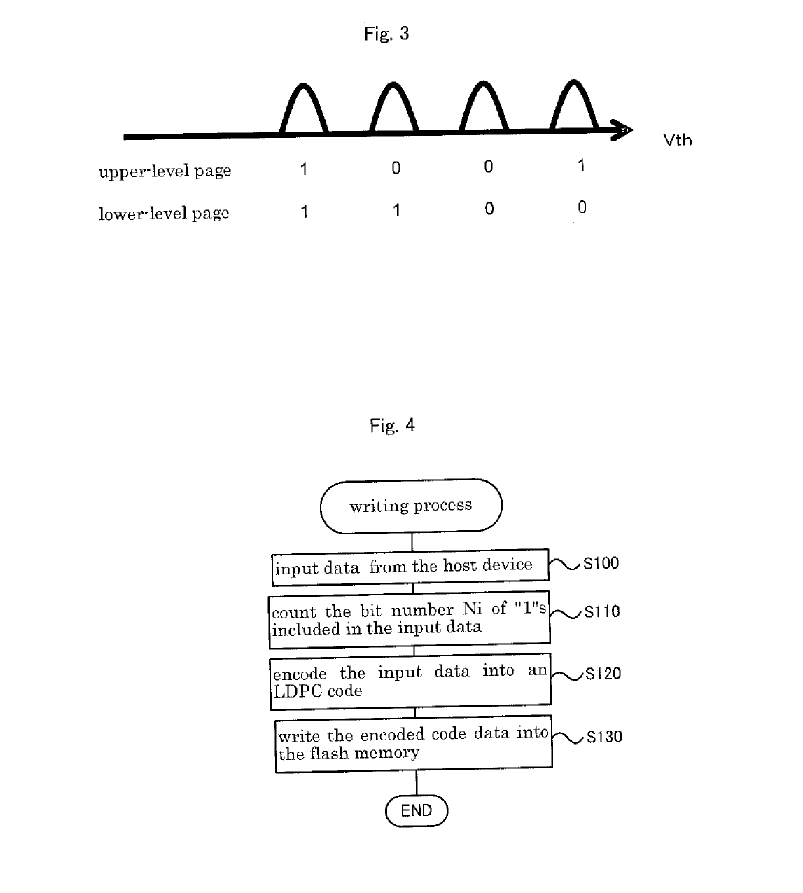

As shown in FIG. 2, the flash memory 22 is configured by a NAND-type flash memory including a flash memory cell array 24 comprised of a plurality of flash memory cells 24a, each having a change in threshold voltage by electron injection into the floating gate or electron withdrawal from the floating gate. The flash memory 22 includes a row decoder, a column decoder and a sense amplifier (all not shown), in addition to the flash memory cell array 24. The flash memory 22 causes data to be written in and read out in a page unit (e.g., 8 kilobytes in the embodiment) and deletes data stored in a block unit consisting of a plurality of pages (e.g., 1 M byte in the embodiment). The flash memory 22 is controlled to operate as a multi-level memory that stores 2-bit data of “11”, “01”, “00” and “10” in an ascending order of the threshold voltage into the flash memory cells 24a as illustrated in FIG. 3. According to the embodiment, the left-side bit array “1001” in the case of writing data in the above order is specified as an upper-level page, and the right-side bit array “1100” is specified as a lower-level page.

The memory controller 30 is configured as a logic circuit included of a plurality of logic elements such as transistors and includes: an N1 counter 31 which inputs data page by page from the host device 10, counts the number of “1”s in the data of the lower-level page with regard to the input one-page data, and outputs the counting result with the input data; an LDPC encoder 32 which encodes the data from the N1 counter 31 into a low-density parity-check (LDPC) code using a check matrix H and controls the flash memory 22 to store the encoded code data into the flash memory 22; an LLR setting unit 34 which controls the flash memory 22 to read out data of one page from the flash memory 22 and sets an upper-level page LLRu as log-likelihood ratio (LLR) of the upper-level page and a lower-level page LLRl as LLR of the lower-level page; an LOPS decoder 36 which performs error correction for the data read out from the flash memory 22 using the set upper-level page LLRu and lower-level page LLRl, decodes the error-corrected data and outputs the decoded data to the host device 10; a W/E counter 38 which counts the number of rewrite times W/E as the number of data erase times with regard to each page of the flash memory 22; and a storage unit 40 which stores an estimated retention time (Tret) setting-table 40a used to set the upper-level page LLRu and the lower-level page LLRl in the LLR setting unit 34, a W/E table 40b storing the number of rewrite times W/E counted by the W/E counter 38 and an EP table 40c. The detailed process of setting the upper-level page LLRu and the lower-level page LLRl in the LLR setting unit 34 and the details of the estimated retention time setting table 40a and the EP table 40c stored in the storage unit 40 is described below.

The LDPC decoder 36 performs error correction for data read out from the flash memory 22 using the upper-level page LLRu and the lower level page LLRl set by the known sum-product decoding method, decodes the error-corrected data and outputs the decoded data to the host device 10. The sum-product decoding method: uses the upper-level page LLRu and the lower-level page LLRl to generate a temporary estimation word c (step S1); uses the check matrix H used for encoding data to determine whether Equation (1) given below is satisfied (step S2); and outputs the temporary estimation word c as decoded data upon satisfaction of Equation (1), whereas updating the upper-level page LLRu and the lower-level page LLRl upon no satisfaction of Equation (1) (step S3). The processing of steps S1 to S3 is repeated until the number of repetitions reaches a predetermined number of repetitions or until Equation (1) is satisfied. This sum-product decoding method is known in the art and is thus not described in detail.

c·HT=0 (1)

The following describes a process of writing data from the host device 10 into the flash memory 22 and a process of reading out data from the flash memory 22 and outputting the read-out data to the host device 10, with regard to the memory controller 30 of the SSD 20 configured as described above.

FIG. 4 is a flowchart showing an exemplary writing process performed by the memory controller 30 to write data from the host device 10 into the flash memory 22. When a writing request signal that requests data to be written into the flash memory 22 is input from the host device 10, the N1 counter 31 of the memory controller 30 receiving the input writing request signal inputs data page by page from the host device 10 (step S100), counts a bit number N1 of “1”s in the lower-level page data with regard to the input one-page data (step S110) and outputs the counting result with the input data to the LDPC encoder 32. When receiving the output data from the N1 counter 31, the LDPC encoder 32 encodes the input data into an LDPC code (step S120) and controls the flash memory 22 to write the encoded code data into the flash memory 22 (step S130). This process causes the input data from the host device 10 with the counting result of the number of “1”s in the lower-level page to be encoded to the LDPC code and written into the flash memory 22.

The following describes a process of reading out data from the flash memory 22 and outputting the read-out data to the host device 10. When a reading request signal that requests data to be read out from the flash memory 22 is input from the host device 10 to the memory controller 30, the LLR setting unit 34 of the flash memory 22 receiving the input reading request signal controls the flash memory 22 to read out data of one page from the flash memory 22, sets the upper-level page LLRu and the lower-level page LLRl and outputs the data read out from the flash memory 22 with the upper-level page LLRu and the lower-level page LLRl to the LDPC decoder 36. When receiving the data read out from the flash memory 22 with the initial values of the upper-level page LLRu and the lower-level page LLRl, the LDPC decoder 36 performs error correction for the read-out data by the sum-product decoding method using the upper-level page LLRu and the lower-level page LLRl, decodes the error-corrected data and outputs the decoded data to the host device 10. This process causes the data from the flash memory 22 to be subject to error correction, thus enhancing the reliability of data.

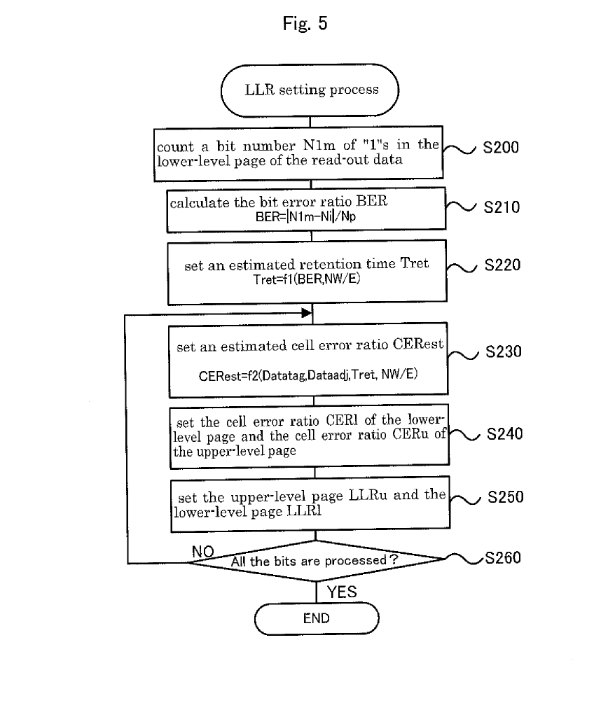

The following describes the detailed process of setting the upper-level page LLRu and the lower-level page LLRl in the LLR setting unit 34. FIG. 5 is a flowchart showing an exemplary LLR setting process to set the upper-level page LLRu and the lower-level page LLRl performed by the LLR setting unit 34. When data of one page is read out from the flash memory 22, the LLR setting unit 34 counts a bit number N1m of “1”s in the lower-level page of the read-out data (step S200) and calculates a bit error ratio BER of the one-page data read out from the flash memory 22 by Equation (2) using the bit number N1m of “1”s in the lower-level page, the bit number Ni of “1”s included in the data prior to encoding, and a bit number Np of the one-page data (step S210). The bit error ratio BER is estimated using the bit number N1m of “1”s in the lower-level page and the bit number Ni of “1”s included in the data prior to encoding, because of the following reason. An error of decreasing the threshold voltage of the flash memory cell 24a occurs in retention errors which are bit errors caused during retention of data stored in the flash memory 22 without data reading and writing. A decrease in threshold voltage is thus detectable by checking an error that changes “0” to “1” in the lower-level page.

BER=|N1m−Ni|/Np (2)

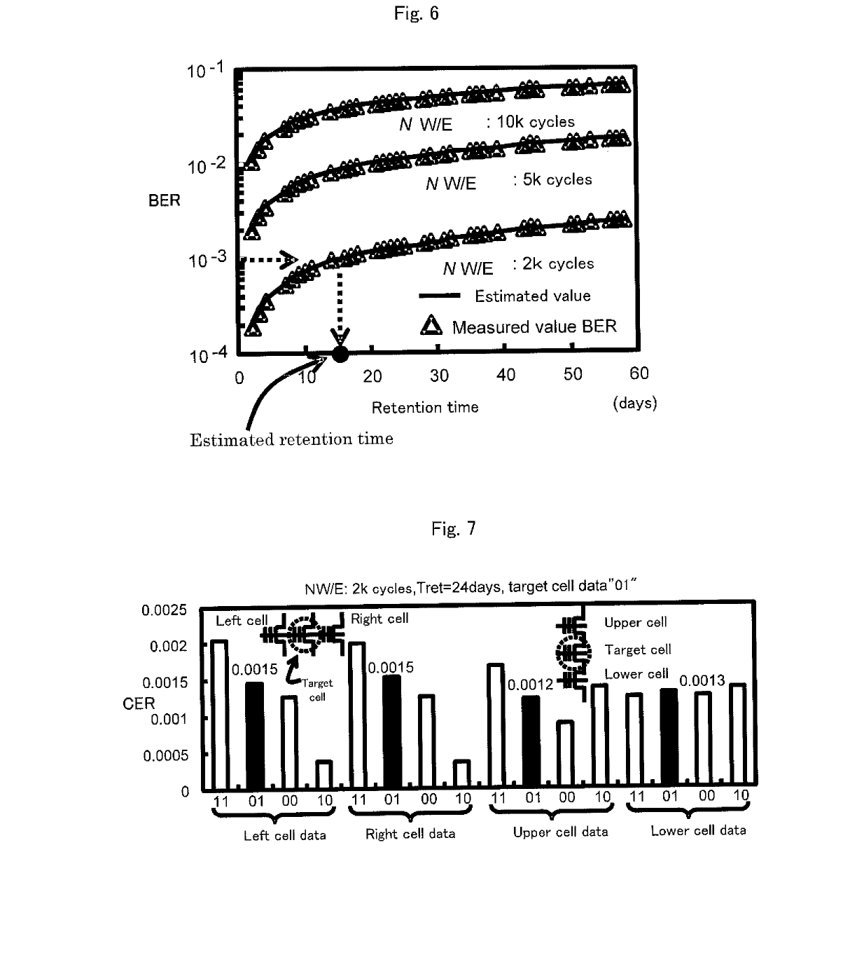

After calculating the bit error ratio BER, the LLR setting unit 34 sets an estimated retention time Tret which is an estimated value of retention time of the flash memory 22 without data reading and writing, based on the calculated bit error ratio BER and the number of rewrite times W/E (step S220). A specific procedure of setting the estimated retention time Tret pre-defines a relationship between the bit error ratio BER, the retention time Tref and the number of rewrite times W/E, stores the pre-defined relationship as the estimated retention time setting table 40a in the storage unit 40 and reads the retention time corresponding to the given bit error ratio HER and the given number of rewrite times W/E from the table to set the estimated retention time Tret. One example of the estimated retention time setting table 40a is shown in FIG. 6.

After setting the estimated retention time Tret, the LLR setting unit 34 sets an estimated cell error ratio CERest which is an estimated value of probability of a bit error caused in a target cell which is one cell of the plurality of flash memory cells 24a storing the one-page data read out from the flash memory, using data Datatag of the target cell, data Dataadj (4) of a left cell, a right cell, an upper cell and a lower cell which are four flash memory cells surrounding the target cell, the estimated retention time Tret and the number of rewrite times W/E (step S230). A specific procedure of setting the estimated cell error ratio CERest stores a pre-defined relationship between the data Datatag and Dataadj (4), the estimated retention time Tret, the number of rewrite times W/E and cell error ratios CER as the EP table in the storage unit 40, reads the cell error ratios CER of the left cell, the right cell, the upper cell and the lower cell corresponding to the given data Datatag and Dataadj (4), the given estimated retention time Tret and the given number of rewrite times W/E from the table and divides the sum of the cell error ratios CER of the left cell, the right cell, the upper cell and the lower cell by a value 4 to calculate the estimated cell error ratio CERest. One example of the EP table is shown in FIG. 7. FIG. 7 illustrates the data of the left cell, the right cell, the upper cell and the lower cell (data Dataadj (4)) and the cell error ratios CER when the data Datatag is “01” and the number of rewrite times W/E is 2000. For example, the cell error ratios CER of the left cell, the right cell, the upper cell and the lower cell are respectively equal to the values 0.0015, 0.0015, 0.0012 and 0.0013 when the data of the left cell, the right cell, the upper cell and the lower cell are all “01” (closed bar graph in the illustration), so that the estimated cell error ratio CERest is calculated by Equation (3) given below. The EP tables as illustrated in FIG. 7 are provided for the respective data Datatag, the respective Dataadj (4) and the respective number of rewrite times W/E.

CERest=(0.0015+0.0015+0.0012+0.0013)/4 (3)

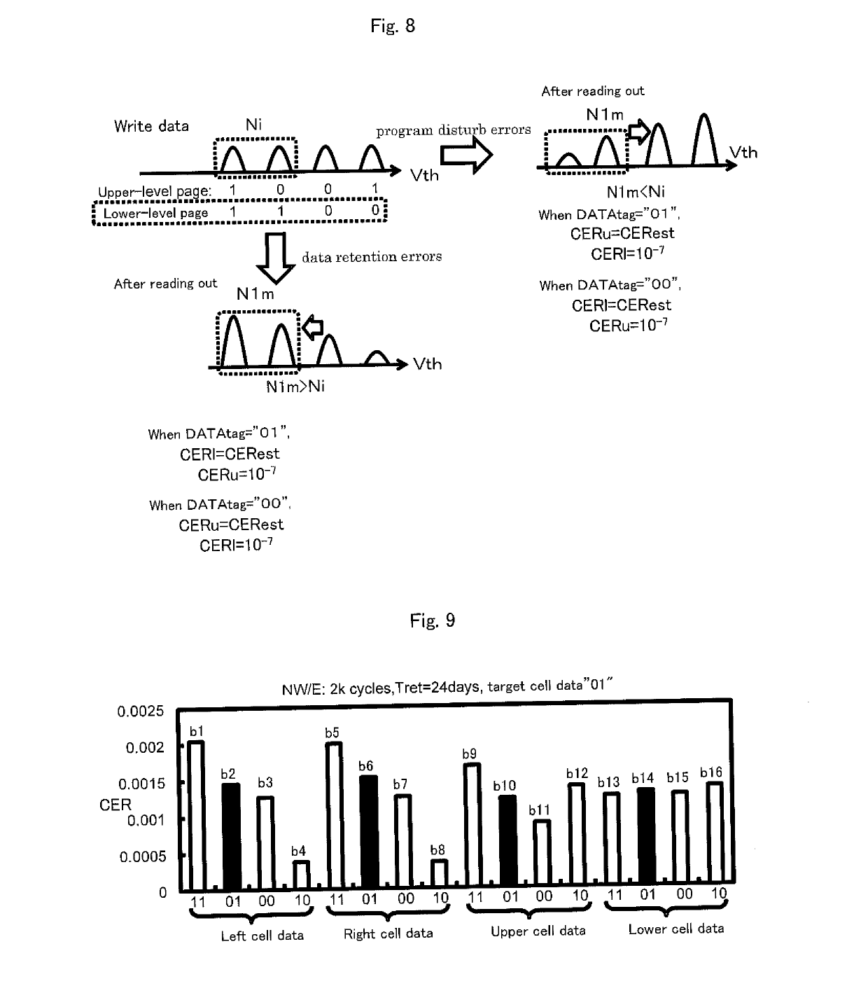

After setting the estimated cell error ratio CERest as described above, the LLR setting unit 34 subsequently sets the cell error ratio GERI of the lower-level page and the cell error ratio CERu of the upper-level page using the estimated cell error ratio CERest (step S240). FIG. 8 is an explanatory diagram illustrating a process of setting the cell error ratio CERl and the cell error ratio CERu. In the 2-bit flash memory cell of the embodiment, the occurrence of an error in the direction of decreasing a threshold voltage Vth is likely to increase the number of “1”s in the data of the lower-level page, whereas the occurrence of an error in the direction of increasing the threshold voltage Vth is likely to increase the number of “0”s in the data of the lower-level page.

In the data retention errors which are errors caused during retention without data reading and writing, an error is likely to occur in the direction of decreasing the threshold voltage Vth. When the bit number Ni of “1”s in the lower-level page prior to encoding is greater than the bit number N1m of “1”s in the lower-level page stored in the flash memory, the data retention errors are accordingly likely to be dominant over program disturb errors caused by injection of hot electron generated in the channel of a flash memory cell unselected for writing into the floating gate of the flash memory cell, thus causing a decrease in threshold voltage Vth. It is thus presumed that an error that changes data of “00” prior to encoding to “01”, i.e., a cell error in the lower-level page, is dominant when the data Datatag is “01”. The estimated cell error ratio CERest is accordingly set to the cell error ratio CERl of the lower-level page, whereas a value predetermined by, for example, experiment or analysis, such as 10⁻⁷ is adequately set to the cell error ratio CERu of the upper-level page. It is also presumed that an error that changes data of “01” prior to encoding to “11”, i.e., a cell error in the upper-level page, is dominant when the data Datatag is “11”. The estimated cell error ratio CERest is accordingly set to the cell error ratio CERu of the upper-level page, whereas a value predetermined by, for example, experiment or analysis, such as 10⁻⁷ is adequately set to the cell error ratio CERl of the lower-level page.

In the program disturb errors, an error is likely to occur in the direction of increasing the threshold voltage Vth. When the bit number Ni of “1”s included in the data prior to encoding is less than the bit number N1m of “1”s in the lower-level page stored in the flash memory, the program disturb errors are accordingly likely to be dominant over the data retention errors. It is thus presumed that an error that changes data of “11” prior to encoding to “01”, i.e., a cell error in the upper-level page, is dominant when the data Datatag is “01”. The estimated cell error ratio CERest is accordingly set to the cell error ratio CERu of the upper-level page, whereas a value obtained by multiplying the setting of the cell error ratio CERu of the upper-level page by a factor α is set to the cell error ratio CERl of the lower-level page. It is also presumed that an error that changes data of “10” prior to encoding to “00”, i.e., a cell error in the lower-level page, is dominant when the data Datatag is “00”. The estimated cell error ratio CERest is accordingly set to the cell error ratio GERI of the lower-level page, whereas a value obtained by multiplying the setting of the cell error ratio CERl of the lower-level page by the factor α is set to the cell error ratio CERu of the upper-level page. As described above, the cell error ratios CERu and CERl are set, based on the bit number N1m of “1”s in the lower-level page stored in the flash memory and the bit number Ni of “1”s included in the data prior to encoding, and the data Datatag and Dataadj.

After setting the cell error ratios CERu and CERl as described above, the LLR setting unit 34 sets the upper-level page LLRu and the lower-level page LLRl based on the data Datatag, the cell error ratios CERu and CERl, the following Equation (4) employed for the data “0” and the following Equation (5) employed for the data “1” (step S250), repeats the processing of steps S230 to S250 with respect to all the bits included in the data (step S260) and then terminates this routine. For example, when the data Datatag is “00”, the upper-level page LLRu and the lower-level page LLRl are set by Equations (6) and (7) which Equation (4) is applied to. As another example, when the data Datatag is “01”, the upper-level page LLRu is set by Equation (6) which Equation (4) is applied to, whereas the lower-level page LLRl is set by Equation (8) which Equation (5) is applied to. In general, data of a certain flash memory cell is affected by what data are stored in other memory cells surrounding the certain memory cell. It is accordingly expected that the cell error ratio in the data of the certain memory cell of interest is changed by the data of the surrounding memory cells. The procedure of the embodiment sets the estimated cell error ratio CERest, based on the estimated retention time Tret obtained from the calculated bit error ratio BER, the number of rewrite times NW/E, the data Datatag of the target cell and the data Dataadj of the memory cells surrounding the target cell, and sets the upper-level page LLRu and the lower-level page LLRl with regard to all the bits in the one-page data read out using the setting of the estimated cell error ratio CERest. This allows for setting the upper-level page LLRu and the lower-level page LLRl further reflecting the actual state of the flash memory cell 24a and thereby enhances the correction capability, compared with the procedure of setting the upper-level page LLRu and the lower-level page LLRl using a pre-assumed distribution of threshold voltage. Since the set upper-level page LLRu and lower-level page LLRl further reflect the actual state of the flash memory cell 24a, there is no need to increase the number of voltages to be referred to in the course of reading out data from the flash memory. This suppresses an increase in number of data read-out times and thereby an increase in processing time. As a result, this improves the error correction capability, while suppressing an increase in processing time.

LLR(0)=log((1−CER)/CER) (4)

LLR(1)=log(CER/(1−CER)) (5)

LLRu=log((1−CERu)/CERu) (6)

LLRl=log((1−CERl)/CERl) (7)

LLRl=log(CERl/(1−CERl)) (8)

The SSD 20 of the embodiment described above sets the estimated cell error ratio CERest, based on the estimated retention time Tret obtained from the calculated bit error ratio BER, the number of rewrite times NW/E, the data Datatag of the target cell and the data Dataadj of the memory cells surrounding the target cell. The SSD 20 subsequently sets the upper-level page LLRu and the lower-level page LLRl with regard to all the bits in the one-page data read out using the setting of the estimated cell error ratio CERest, and performs error correction and decoding of data read out from the flash memory 22 using the settings of the upper-level page LLRu and the lower-level page LLRl. This improves the error correction capability, while suppressing an increase in processing time.

The SSD 20 of the embodiment takes into account the bit error ratio BER and the number of rewrite times NW/E and sets the estimated retention time Tret using the bit error ratio BER, the number of rewrite times NW/E and the estimated retention time setting table 40a illustrated in FIG. 6 at step S220 in the LLR setting process routine of FIG. 5. Alternatively, one modification may define the relationship between the bit error ratio BER and the number of rewrite times NW/F as the estimated retention time setting table 40a without taking into account the number of rewrite times NW/E and set the estimated retention time Tret from the bit error ratio BER and the estimated retention time setting table 40a.

The SSD 20 of the embodiment calculates the bit error ratio BER with regard to the read-out one-page data at step S210 in the LLR setting process routine of FIG. 5. The bit error ratio BER may, however, be calculated with regard to data of any plurality of bits. For example, the bit error ratio BER may be calculated with regard to data of not less than one page, or alternatively the bit error ratio BER may be calculated with regard to data of less than one page.

The SSD 20 of the embodiment counts the bit number Ni of “1”s included in the input data at step S110 in the writing process routine of FIG. 4, and counts the bit number N1m of “1”s in the lower-level page of the read-out data and calculates the bit error ratio BER using the bit number N1m of “1”s in the lower-level page, the bit number Ni of “1”s included in the data prior to encoding and the bit number Np of the one-page data at steps S200 and S210 in the LLR setting process routine of FIG. 5. Alternatively, one modification may count the bit number of “0”s included in the input data at step S110, and count the bit number of “0”s in the lower-level page of the read-out data and calculate the bit error ratio BER using the bit number of “0”s in the lower-level page, the bit number of “0”s included in the data prior to encoding and the bit number Np of the one-page data at steps S200 and S210 in the LLR setting process routine of FIG. 5. In this latter case, the calculated bit error ratio regards errors that increase the threshold voltage of the memory cell and change the data from “1” to “0” in the low-level page, for example, program disturb errors.

The SSD 20 of the embodiment takes into account the data Datatag and Dataadj (4), the estimated retention time Tret and the number of rewrite times W/E and sets the estimated cell error ratio CERest using the data Datatag and Dataadj (4), the estimated retention time Tret, the number of rewrite times W/E and the EP table at step S230 in the LLR setting process routine of FIG. 5. Alternatively, one modification may define the relationship between the data Datag and Dataadj (4), the estimated retention time Tret and the estimated cell error ratio CERest as the EP table without taking into account the number of rewrite times W/E and set the estimated cell error ratio CERest using the EP table, the data Datatag and Dataadj (4) and the estimated retention time Tret.

The SSD 20 of the embodiment sets the estimated retention time Tret and sets the estimated cell error ratio CERest using the estimated retention time Tret at steps S220 and S230 in the LLR setting process routine of FIG. 5. Alternatively, one modification may skip the processing of step S220 and set the estimated cell error ratio CERest using the bit error ratio BER instead of the estimated retention time at step S230.

The SSD 20 of the embodiment takes into account the data Dataadj (4) of the left cell, the right cell, the upper cell and the lower cell which are the four flash memory cells surrounding the target cell and sets the estimated cell error ratio CERest at step S230 in the LLR setting process routine of FIG. 5. The estimated cell error ratio CERest may, however, be set by taking into account flash memory cells in any specified range surrounding the target cell, for example, eight memory cells surrounding the target cell or flash memory cells in a two-line range of the target cell, i.e., twenty four flash memory cells.

The SSD 20 of the embodiment calculates the estimated cell error ratio CERest by Equation (3) given above. Alternatively, one modification may adequately calculate the estimated cell error ratio CERest by taking into account contributions of the respective cells, for example, by multiplying the cell error ratios CER of the left cell, the right cell, the upper cell and the lower cell by respective weighting factors. Another modification may calculate the estimated cell error ratio CERest by Equation (9) given below. As shown in FIG. 9, b1 to b16 of Equation (9) respectively denote the cell error ratios CER when the data of the left cell are “11”, “01”, “00” and “10”, cell error ratios CER when the data of the right cell are “11”, “01”, “00” and “10” and the cell error ratios CER when the data of the upper cell are “11”, “01”, “00” and “10” in the EP table 40c illustrated in FIG. 7.

$$CERest = BER \times \frac{4 {b}_{2}}{{\sum }_{k = 1}^{4} {b}_{k}} \times \frac{4 {b}_{6}}{{\sum }_{k = 5}^{8} {b}_{k}} \times \frac{4 {b}_{10}}{{\sum }_{k = 9}^{12} {b}_{k}} \times \frac{4 {b}_{14}}{{\sum }_{k = 13}^{16} {b}_{k}} \qquad ( 9 )$$

The SSD 20 of the embodiment sets the value predetermined by, for example, experiment or analysis such as 10⁻⁷ to the cell error ratio CERu of the upper-level page. Alternatively, the cell error ratio CERu of the upper-level page may be set by any suitable method, for example, by using the cell error ratio CERl of the lower-level page.

The SSD 20 of the embodiment employs the sum-product decoding method for decoding data encoded into the LDPC code. The decoding technique employed may be a method of decoding by an operation using the log-likelihood ratio (LLR), for example, min-sum algorithm.

In the SSD 20 of the embodiment, the flash memory 22 is provided as the memory controlled to store 2-bit data in each flash memory cell 24a. The flash memory 22 may, however, be a memory controlled to store 1-bit data in each flash memory cell 24a or a memory controlled to store data of a bit number greater than 2 bits in each flash memory cell 24a.

The SSD 20 of the embodiment encodes the input data into the LDPC code. The error correction code is, however, not limited to the LDPC code but may be any error correction code which is decodable to the input data by an operation using the LLR.

The SSD 20 of the embodiment has the NAND-type flash memory 22 mounted thereon. The memory mounted on the SSD 20 is, however, not limited to the NAND-type flash memory 22 but may be any non-volatile memory that maintains data even after stop of power supply, for example, an NOR-type flash memory or a resistance random access memory.

According to the above embodiment, the memory controller of the invention is mounted on the SSD. According to another embodiment, however, the memory controller may be mounted on a personal computer to control a USB memory inserted into the personal computer.

The embodiment describes the application of the memory control of the invention to the SSD. The scope of the application is, however, not limited to the SSD, but the invention may be applied to any storage device that is capable of storing data.

The following describes the correspondence relationship between the primary components of the embodiment and the primary components of the invention described in Summary of Invention. With respect to the memory controller, the N1 counter 31 and the LLR setting unit 34 that perform the processing of step S110 in the writing process routine of FIG. 4 and the processing of steps S200 and S210 in the LLR setting process routine of FIG. 5 in the embodiment correspond to the “bit error ratio calculator”. The LLR setting unit 34 that performs the processing of steps S220 to S240 in the LLR setting process routine of FIG. 5 corresponds to the “estimated cell error probability setter”. The LLR setting unit 34 that performs the processing of step S250 in the LLR setting process routine of FIG. 5 corresponds to the “log-likelihood ratio setter”. With respect to the data storage device, the memory controller 30 of the embodiment corresponds to the “memory controller”, and the flash memory 22 corresponds to the “non-volatile memory.”

The correspondence relationship between the primary components of the embodiment and the primary components of the invention, regarding which the problem is described in Summary of Invention, should not be considered to limit the components of the invention, regarding which the problem is described in Summary of Invention, since the embodiment is only illustrative to specifically describes the aspects of the invention, regarding which the problem is described in Summary of Invention. In other words, the invention, regarding which the problem is described in Summary of Invention, should be interpreted on the basis of the description in the Summary of Invention, and the embodiment is only a specific example of the invention, regarding which the problem is described in Summary of Invention.

The aspect of the invention is described above with reference to the embodiment. The invention is, however, not limited to the above embodiment but various modifications and variations may be made to the embodiment without departing from the scope of the invention.

### INDUSTRIAL APPLICABILITY

The present invention is applicable to, for example, the manufacturing industries of memory controllers and data storage devices.

1-11. (canceled)

12. A memory controller configured such as to, in the case of writing data into a non-volatile memory having a plurality of non-volatile memory cells, encode the data to be written into a specified code which is decodable by an operation using a log-likelihood ratio and control the non-volatile memory to store the encoded code data into the non-volatile memory, and in the case of reading out data from the non-volatile memory, control the non-volatile memory to read out code data of a predefined size from the non-volatile memory and decode the code data by the operation using the log-likelihood ratio, the memory controller comprising:
a bit error ratio calculator that, when code data of a predefined size is read out from the non-volatile memory, calculates a bit error ratio which is a ratio of a number of bits where a bit inversion error occurs in the read-out data of the predefined size to a total number of bits in the read-out data of the predefined size;
an estimated cell error probability setter that performs an estimated cell error probability setting process with regard to all bits of the read-out data of the predefined size, wherein the estimated cell error probability setting process sets an estimated cell error probability, which is an estimated value of probability of occurrence of a bit error in a target cell that is a non-volatile memory cell storing 1 bit of the read-out data of the predefined size, based on the calculated bit error ratio, data of the target cell and data of a non-volatile memory cell in a specified range from the target cell; and
a log-likelihood ratio setter that sets the log-likelihood ratio with regard to all the bits of the read-out data of the predefined size using the set estimated cell error probability.

13. The memory controller according to claim 12,
wherein the estimated cell error probability setting process sets an estimated retention time, which is an estimated value of retention time without data reading and writing from and to the non-volatile memory, using the calculated bit error ratio, and sets the estimated cell error probability using the set estimated retention time, the data of the target cell and the data of the non-volatile memory cell in the specified range from the target cell.

14. The memory controller according to claim 2, further comprising:
a first table storage unit that stores a first table predefined as a relationship between the bit error ratio and the estimated retention time; and
a second table storage unit that stores a second table predefined as a relationship between the estimated retention time, the data of the target cell and the data of the non-volatile memory cell in the specified range from the target cell, wherein
the estimated cell error probability setting process sets the estimated retention time using the calculated bit error ratio and the first table, and sets the estimated cell error probability using the set estimated retention time, the data of the target cell, the data of the non-volatile memory cell in the specified range from the target cell and the second table.

15. The memory controller according to claim 13, further comprising:
a rewrite time counter that counts a number of rewrite times which is a number of erase times of data stored in the non-volatile memory, wherein
the estimated cell error probability setting process sets the estimated cell error probability using the counted number of rewrite times, the set estimated retention time, the data of the target cell and the data of the non-volatile memory cell in the specified range from the target cell.

16. The memory controller according to claim 15,
wherein the second table is predefined as a relationship between the number of rewrite times, the estimated retention time, the data of the target cell, the data of the non-volatile memory cell in the specified range from the target cell and the estimated cell error probability, wherein
the estimated cell error probability setting process sets the estimated cell error probability using the counted number of rewrite times, the set estimated retention time, the data of the target cell, the data of the non-volatile memory cell in the specified range from the target cell and the second table.

17. The memory controller according to claim 15,
wherein the first table is predefined as a relationship between the bit error ratio, the estimated retention time and the number of rewrite times, wherein
the estimated cell error probability setting process sets the estimated retention time using the calculated bit error ratio, the number of rewrite times and the first table.

18. The memory controller according to claim 12,
wherein when data is written into the non-volatile memory, the bit error ratio calculator stores a bit number of “1”s or “0”s included in data of the predefined size stored in the non-volatile memory out of the data to be written, prior to encoding the data to be written into the specified code, as a pre-coding bit number, and
when data of the predefined size is read out from the non-volatile memory, the bit error ratio calculator calculates the bit error ratio using a bit number of “1”s or “0”s of the read-out data and the pre-coding bit number.

19. The memory controller according to claim 12,
wherein the non-volatile memory is a flash memory, and
the data of the predefined size is one-page data of the flash memory.

20. The memory controller according to claim 19,
wherein the non-volatile memory is a NAND-time flash memory including the non-volatile memory cells, each being capable of storing 2-bit data, wherein
when an upper-level page is defined as 1001 in an ascending order of a threshold voltage in the data stored in the non-volatile memory cell and a lower-level page is defined as 1100 in the ascending order of the threshold voltage, the bit error ratio calculator calculates an error that changes “1” to “0” in the lower-level page, as the bit error ratio.

21. The memory controller according to claim 12,
wherein the specified code is a low-density parity-check code.

22. A data storage device that is capable of storing data, comprising:
a memory controller configured such as to, in the case of writing data into a non-volatile memory having a plurality of non-volatile memory cells, encode the data to be written into a specified code which is decodable by an operation using a log-likelihood ratio and control the non-volatile memory to store the encoded code data into the non-volatile memory, and in the case of reading out data from the non-volatile memory, control the non-volatile memory to read out code data of a predefined size from the non-volatile memory and decode the code data by the operation using the log-likelihood ratio, the memory controller comprising: a bit error ratio calculator that, when code data of a predefined size is read out from the non-volatile memory, calculates a bit error ratio which is a ratio of a number of bits where a bit inversion error occurs in the read-out data of the predefined size to a total number of bits in the read-out data of the predefined size; an estimated cell error probability setter that performs an estimated cell error probability setting process with regard to all bits of the read-out data of the predefined size, wherein the estimated cell error probability setting process sets an estimated cell error probability, which is an estimated value of probability of occurrence of a bit error in a target cell that is a non-volatile memory cell storing 1 bit of the read-out data of the predefined size, based on the calculated bit error ratio, data of the target cell and data of a non-volatile memory cell in a specified range from the target cell; and a log-likelihood ratio setter that sets the log-likelihood ratio with regard to all the bits of the read-out data of the predefined size using the set estimated cell error probability; and
the non-volatile memory.

23. The memory controller according to claim 14, further comprising:
a rewrite time counter that counts a number of rewrite times which is a number of erase times of data stored in the non-volatile memory, wherein
the estimated cell error probability setting process sets the estimated cell error probability using the counted number of rewrite times, the set estimated retention time, the data of the target cell and the data of the non-volatile memory cell in the specified range from the target cell.

24. The memory controller according to claim 23,
wherein the second table is predefined as a relationship between the number of rewrite times, the estimated retention time, the data of the target cell, the data of the non-volatile memory cell in the specified range from the target cell and the estimated cell error probability, wherein
the estimated cell error probability setting process sets the estimated cell error probability using the counted number of rewrite times, the set estimated retention time, the data of the target cell, the data of the non-volatile memory cell in the specified range from the target cell and the second table.

25. The memory controller according to claim 23,
wherein the first table is predefined as a relationship between the bit error ratio, the estimated retention time and the number of rewrite times, wherein
the estimated cell error probability setting process sets the estimated retention time using the calculated bit error ratio, the number of rewrite times and the first table.
